(19) United States
(12) Patent Application Publication
(10) Pub. No.: US 2025/0272674 A1
(43) Pub. Date: Aug. 28, 2025

(54) PAYMENT RAIL FOR ON-CHAIN PAYMENTS

(71) Applicant: State Farm Mutual Automobile Insurance Company, Bloomington, IL (US)

(72) Inventors: Jacob Braun, Oviedo, FL (US); Rachel Modi, Monroe Twp, NJ (US); Andrea "Andy" Irving, Bloomington, IL (US); Josh DeKeersgieter, Columbus, OH (US); Justin Johnsen, Heyworth, IL (US); Emily Burger, Boston, MA (US)

(21) Appl. No.: 18/589,225

(22) Filed: Feb. 27, 2024

(51) Int. Cl. G06Q 20/36; H04L 9/00

(52) U.S. Cl. CPC G06Q 20/3678; H04L 9/50

(57) ABSTRACT

A method for sending an on-chain digital property by a digital property rail that includes entering, into an application, the address of a crypto-distributed account with a policy number to set up a digital property rail for sending the on-chain digital property from the application to a crypto-distributed account of a corporate entity. Also, performing a querying operation based on the crypto-distributed account address that has been entered, to determine the address of the crypto-distributed account of the corporate entity. In response to determining the crypto-distributed account address, determining a distributed record number associated with the crypto-distributed account address of the corporate entity to create the digital property rail to send the on-chain digital property to the crypto-distributed account of the corporate entity

### TECHNICAL FIELD

The present disclosure relates to configuring a payment rail for on-chain payments to a crypto wallet, and more particularly to enabling a digital payment platform that uses a payment rail to send an on-chain payment to a corporate crypto wallet address.

### BACKGROUND

The use of digital money by consumers is becoming more ubiquitous for payment of services. Payment rails are being implemented and constitute the underlying infrastructure and systems that facilitate the transfer of digital funds between parties (such as individuals, businesses, and financial institutions). The time taken to process transactions can vary significantly across different payment rails.

Conventional systems and methods may use centralized databases or storage mechanisms to store user information that can be used to identify users. This centralized database scheme typically allows updates and transactions to occur only in a synchronous fashion, where transactions stored in the database are serialized to occur one at a time. Such transactions are typically controlled and accessed by a single entity; for example, a company or private institution that controls the centralized database or storage mechanism.

A crypto wallet is an interface that allows access to managed funds on a blockchain. The blockchain may be considered a type of decentralized database network that keeps records of blockchain transactions, which can be used to store various types of digital transactions. Rather than having a single entity control a traditional database, a blockchain-based network can include a network of replicated databases that can be synchronized via a public network (e.g., the Internet), and, therefore visible to anyone within the network. Blockchain networks can also, however, be private with restricted membership similar to an intranet.

It is desirable to enable a corporate cryptocurrency blockchain address (e.g., a crypto wallet address) to receive payments from various senders where the anonymity of the payor can be maintained and the payment can be executed and identified without having a profile or policy-specific information included with an automated routine executing the payment to the general cryptocurrency blockchain.

The systems and methods described herein may be at least directed toward using software applications for confirming a transaction at a crypto blockchain address using an executable automated routine where a general crypto blockchain address has been identified for executing the automated routine for a cryptocurrency payment.

### SUMMARY

Described herein are systems and methods to set up a payment rail for an on-chain payment to an address of a crypto wallet of a corporate entity. In some examples, the corporate entity can be an insurance company (or other contract service provider) that has set up a crypto wallet to receive a digital money payment (or a series of digital money payments) at a general corporate wallet address. In some examples, the general corporate wallet address is a blockchain address.

In some examples, a method for sending on-chain digital property is provided. The method includes configuring at an application, an address of a crypto-distributed account with a policy number for creating a digital property rail to transfer the on-chain digital property using the address from the application to a crypto-distributed account used by a corporate entity. Then, the method includes querying, by the application using the crypto-distributed account address to discover the address used by the crypto-distributed account of the corporate entity. In response to discovering the crypto-distributed account address of the corporate entity, the method includes recording a distributed record number associated with the crypto-distributed account address of the corporate entity that receives the on-chain digital property being sent to the crypto-distributed account of the corporate entity. Also, the method may include executing an automated routine associated with the crypto-distributed account using the distributed record number to make the transfer of the on-chain digital property to the crypto-distributed account of the corporate entity.

In some examples, the method further includes sending the on-chain digital property using the digital property rail to the crypto-distributed account of the corporate entity within a predetermined time in response to receiving the distributed record number by the application.

In some examples, the method further includes configuring the automated routine to emit a digital property value of the on-chain digital property sent to the crypto-distributed account of the corporate entity.

In some examples, the method further includes receiving a confirmation by the application of the on-chain digital property to the crypto-distributed account of the corporate entity in response to executing the automated routine to implement the digital property rail of the on-chain digital property.

In some examples, the method further includes providing, by the application, at least one of a policy identifier or a policyholder identifier when sending the on-chain digital property to the crypto-distributed account of the corporate entity.

In some examples, the method further includes providing, by the application, information to match the on-chain digital property to at least one of a policy identifier or an amount of the on-chain digital property to account when sending the on-chain digital property to the crypto-distributed account of the corporate entity.

In some examples, the method further includes generating by the application a receipt of digital property in response to receiving an account of the on-chain digital property to the crypto-distributed account of the corporate entity. The application may be hosted by a client device. The automated routine for on-chain digital property uses an independent digital property rail. The automated routine is configured to emit at least an address of a policyholder associated with the digital property to the crypto-distributed account of the corporate entity.

In some examples, a system is provided. The system includes at least one memory; and at least one processor coupled to the at least one memory, wherein the at least one processor is configured to: receive an address of a crypto-distributed account with a policy number to set up a digital property rail for sending the on-chain digital property to a crypto-distributed account of a corporate entity; perform a query operation based on the crypto-distributed account address that has been entered to determine the address of the crypto-distributed account of the corporate entity; in response to determining the crypto-distributed account address, discover a distributed record number associated with the crypto-distributed account address of the corporate entity to enable set up of the digital property rail to send the on-chain digital property to the crypto-distributed account of the corporate entity; and apply an automated routine associated with the crypto-distributed account configured with the set-up of the digital property rail that uses the distributed record number to send the on-chain digital property to the crypto-distributed account of the corporate entity.

In some examples, at least one processor is further configured to: in response to receiving the distributed account number, send the on-chain digital property using the digital property rail to the crypto-distributed account of the corporate entity within a predetermined time.

In some examples, at least one processor is further configured to cause the automated routine to emit at least a digital property value of the on-chain digital property sent to the crypto-distributed account of the corporate entity.

In some examples, at least one processor is further configured to cause the automated routine to emit at least an address of a policyholder associated with the on-chain digital property to the crypto-distributed account of the corporate entity.

In some examples, at least one processor is further configured to provide at least one of a policy identifier or a policyholder identifier when sending the on-chain digital property to the crypto-distributed account of the corporate entity.

In some examples, at least one processor is further configured to provide information to match the on-chain digital property to at least one of the policy identifiers or an amount of the on-chain digital property to account for sending of the on-chain digital property to the crypto-distributed account of the corporate entity.

In some examples, at least one processor is further configured in response to receiving an account of the on-chain digital property to the crypto-distributed account of the corporate entity, to generate a receipt of digital property.

In some examples, one or more non-transitory computer-readable media storing instructions executable by a processor, wherein the instructions, when executed by the processor, cause the processor to perform operations including receiving an address of a crypto-distributed account with a policy number to set up a digital property rail for sending the on-chain digital property to a crypto-distributed account of a corporate entity; performing a query operation based on the crypto-distributed account address that has been entered, to determine the address of the crypto-distributed account of the corporate entity; in response to determining of the crypto-distributed account address, generating a result of a distributed account number associated with the crypto-distributed account address of the corporate entity to enable set up of the digital property rail for sending the on-chain digital property to the crypto-distributed account of the corporate entity; and applying an automated routine associated with the crypto-distributed account configured with the set-up of the digital property rail that relies in part on the distributed account number to send the on-chain digital property to the crypto-distributed account of the corporate entity.

In some examples, the instructions, when executed by the processor, cause the processor to further perform operations including in response to receiving the distributed account number, sending the on-chain digital property using the digital property rail to the crypto-distributed account of the corporate entity within a predetermined time.

In some examples, the instructions, when executed by the processor, cause the processor to further perform operations including in response to executing the automated routine to implement the digital property rail of the on-chain digital property, receiving a confirmation of the on-chain digital property to the crypto-distributed account of the corporate entity.

### BRIEF DESCRIPTION OF THE DRAWINGS

The detailed description is set forth with reference to the accompanying figures. In the figures, the left-most digit(s) of a reference number identifies the figure in which the reference number first application appears. The use of the same reference numbers in different figures indicates similar or identical items or features.

FIG. 1 shows an example payment processing system for processing a crypto payment to a crypto wallet of a corporate entity according to some embodiments.

FIG. 2 shows an example network for processing the crypto payment according to some embodiments.

FIGS. 3A, 3B, 3C, 3D, 3E, 3F, 3G, 3H, 3I, 3J, 3K, and 3L show a series of example screenshots of the process flow for configuring a crypto wallet and sending a crypto payment to a general blockchain wallet of a corporate entity according to some embodiments.

FIG. 4 shows a flowchart of an example method for processing a crypto payment according to some embodiments.

FIG. 5 shows an example system architecture for a computing system that can host the application and process the crypto payment according to some embodiments.

### DETAILED DESCRIPTION

This disclosure describes techniques for crypto payment solutions to set up or configure a payment rail to make digital transfers and payments that can be considered on-chain payments to a corporate crypto wallet. In some examples, this disclosure defines digital or crypto payments to include payments of virtual products such as on-chain digital property, digital payment, digital money transfers, crypto payments, or other virtual-type currency payments. For example, the sending of an on-chain digital property may be defined as the sending of crypto payment to a crypto wallet.

In some examples, a payment rail can be defined as a method or system that facilitates the transfer of funds between parties, such as individuals, businesses, and financial institutions. The payment rail can enable the secure and efficient movement of digital money or property transactions. A cryptocurrency transaction on a payment rail may be considered a digital payment rail exchanged on a blockchain network.

In some examples, the disclosure describes an on-chain payment or payment of an on-chain digital property that may be associated with or identified with a policyholder when the on-chain payment is sent on a payment rail by matching policy identifiers and payment amounts made with information being monitored at a blockchain associated with a blockchain address for receiving the digital fund transfers.

In some examples, the disclosure describes a payment rail as a digital property rail or an on-chain payment rail for making a digital or crypto payment or a fund transfer to a crypto wallet. In some examples, the crypto-wallet may be defined as a crypto-distributed account, a blockchain account, a blockchain ledger, or a database record in which the on-chain digital property (digital payment) is transferred or sent using a blockchain account number (or a distributed account number).

In some examples, a crypto wallet may be defined as an interface that can provide access and payment management on a blockchain. In some examples, a blockchain may be considered a distributed record or an accounting ledger.

In some examples, the systems and methods are provided for confirmation of a crypto payment when a transaction has been executed with an automated routine (or automated script) that may be a smart contract. The smart contract can be configured to execute the transaction from a crypto wallet using a generated block number from an application for making the on-chain payment. In some examples, the on-chain payment is made within a certain window of time.

In some examples, the configured smart contract (or automated routine) and payment window may enable immediate confirmation of the payment to the payor and the policyholder. Also, the smart contract when executed is devoid of user, profile, or policy-specific information and uses a configured block number from an application that the user can transfer for use with an independent crypto wallet for making the payment.

In some examples, systems and methods are provided or interface with the corporate wallet to monitor a blockchain or crypto-distributed wallet address to automatically match incoming crypto payments made by a payor or policyholder using data gleaned from data of an upcoming payment such as the payment amount, the time of payment, and the date to record/document the transaction; and without compromising the anonymity of the payment source that is relied upon using a crypto payment source.

In some examples, systems, and methods are provided that provide instant or nearly immediate confirmation to a payor or policyholder of a crypto payment that is made to a general corporate crypto wallet wherein the crypto payment is sent from an independent crypto wallet and the crypto payment may be of one or more types of virtual or cryptocurrency products.

In some examples, the crypto wallet of a corporate entity is configured with processes that provide the capability to match the incoming cryptocurrency payment to a particular insurance policy without using policy-specific information and by using prior data received associated with an upcoming crypto payment being sent and the amount of the crypto payment being sent. For example, the upcoming crypto payment amount to be sent may be collected from the input by a policyholder's application where the application notifies the application that payment should be sent to a particular corporate wallet or distributed account address (e.g., the blockchain ledger address of the corporate entity to receive crypto payments). The application may also provide guidance such as the crypto payment should be made within a certain timeframe, and the amount of the payment to be made is confirmed in the policyholder's application.

In some examples, the application provides instant or nearly instant confirmation of the payment receipt upon execution of a smart contract (or automated routine) associated with an independent wallet configured with the general wallet address of the payment. The smart contract associated with the blockchain of the crypto payment is separated and may be considered an isolated distributed account address to receive crypto payments from anonymous senders. That is, the smart contract making the payment is not configured with specific policy or user information that is sent along with crypto payment to the general wallet address (e.g., the distributed account address).

In some examples, the smart contract is configured as a payment routine that is set up with a general wallet address (generated via a link that includes a block number associated with the payor's address) of the insurance company to send the payment. The payment is sent to the general wallet address of the corporate company such as an insurance company and is automatically matched based at the time of the payment.

In some examples, based on the crypto payment amount or value, and a monitored time of receipt of the crypto payment, the crypto payment or transfer is realized and a confirmation is sent to the policyholder. The confirmation may be sent via an application that the policyholder logs into to receive a notification that the crypto payment or transfer has been made and the value of the cryptocurrency transfer to a policyholder's account.

In some examples, methods, and systems are provided for the use of a universal corporate wallet to receive using a payment rail to make an on-chain crypto payment (e.g., an automated configured cryptocurrency payment) that uses the following components: (1) link with a blockchain or distribute account address to send or transfer the crypto product or property, (2) a function that causes a query operation of a crypto wallet to determine a block number that is set up with the crypto wallet and the particular virtual or digital currency stored in the wallet, (3) information to relay to the sender of the payment within a time frame or window to execute or send the payment from an anonymous crypto wallet, and (4) an application for the policyholder to log into that confirms a settlement of an amount due to the corporate entity or an amount that has been credited to a policy holder's account.

In some examples, the customer enters information about the crypto wallet or distributed account address along with the policy number, and the application queries the distributed accounts to get the blockchain number. This block number is provided to the user (from a link in the application), and the user is given a certain time limit to submit the transaction. The timing window enables a secure matching of payment to policy. The user logs into the application and indicates that he will be making a payment within a certain time. The application monitors for payment of a given amount within the time period. It does not have any other information to associate with the payee but the timing and the payment amount.

In some examples, a smart contract responsible for taking in payments is applied to the blockchain and it is also able to emit the corporate wallet address and payment value.

In some examples, a graphical user interface is configured that allows the user to receive the link to configure the smart contract for payment and make payments within a limited time using the user's crypto wallet and the corporate general crypto wallet address.

In some examples, the graphic user interface is configured to confirm the payment to the user upon the settlement processing (by a crypto payment processing system) and without requiring a recording and/or confirmation of the payment received from the corporate entity's blockchain wallet.

In some examples, the corporate entity is an insurance company or provider of insurance services.

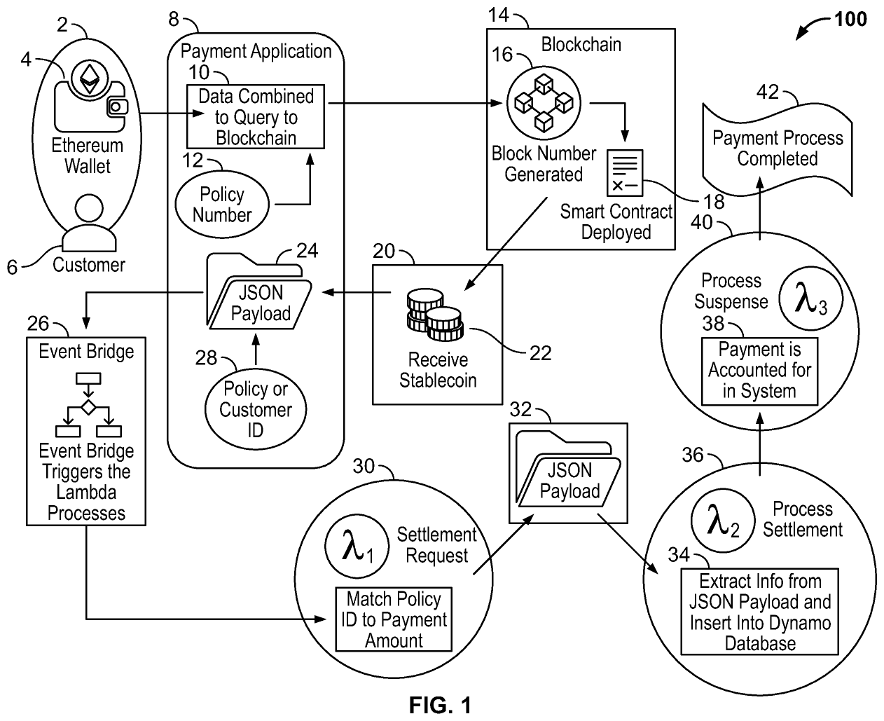

FIG. 1 illustrates the architecture of an example cryptocurrency processing system that uses a corporate wallet (e.g., a crypto-distributed account) to receive isolated crypto payments and to provide confirmation of the payment. In some examples, the confirmation may be provided before recording (e.g., before an actual recording of the payment to crypto distributed account) the digital payment at the corporate crypto wallet according to some embodiments.

In FIG. 1 in the cryptocurrency processing system 100, at block 2, a crypto wallet 4, in this case an Ethereum blockchain wallet is configured, though other types of crypto wallets can also be used or enabled by the customer 6 for making a payment. While the crypto wallet 4 is described as using Ethereum digital products, other types of digital products or properties are equally or similarly feasible. For example, other types of decentralized blockchain with smart contract functionality can be implemented for sending a digital payment or a digital property transfer using various types of scripts, smart contracts, and automated routines to enable different payment rails to process payments to distributed crypto accounts. In an example, customer 6 may enter a crypto wallet address (e.g., a distributed account address) into application 8 (e.g., the corporate entity application such as an insurance companies' configured application) to enable the application 8 to perform a query to determine or discover the Ethereum wallet or a distributed account address (e.g., a blockchain ledge address). Application 8 combines data of a policy number 12 that the customer 6 or the user wants to make or send a digital type of payment or transfer of a digital property or product for payment to the corporate entity.

In some instances, application 8 is configured to use the combined data 10 to query the blockchain 14 (e.g., the Ethereum distributed account, blockchain) to get a blockchain number 16 (e.g., for example, to determine a distributed account number associated with a distributed account address) for use in processing a payment by the automated script or smart contract 18. In some examples, the blockchain number 16 (or block number, distributed record number, etc.) may be used by the automated routine of smart contract 18 that is applied by a payment sender's wallet to send a cryptocurrency 20. In some examples, the cryptocurrency 20 may include a digital product or digital property that is configured as a stable coin 22 (e.g., a crypto product that is valued or tied to another currency or financial instrument). In some examples, the stablecoin 22 is configured by a digital payload that can include JSON scripted or hashed payload 24 that is enabled in a payment rail that uses an event bridge 26 that is set up to trigger a function such as user-defined or automated routine (e.g., such as a lambda or other anonymous function) to process and settle the digital payment at a distributed account address. In some examples, the user-defined processing function may be a settlement-type lambda (lambda function λ) processing.

In some examples, the blockchain number 16 (or distributed account number or distributed block number) that is generated and provided to the customer 6 (or user of the application) may be automatically generated in the application 8 in a graphical user interface for selection by the user. For example, application 8 may generate a link that includes the blockchain or distributed account number (e.g., a record number associated with a particular blockchain for receiving the digital transfer), and the customer or other user may be given a certain time limit to submit the transaction. In some examples, application 8 may allow the user to input the amount of time required to perform the action of selecting and configuring an automated routine or smart contract in a setup of a crypto wallet to send the payment to the corporate crypto wallet. In some examples, after the time to make a digital payment is inputted by the user or preconfigured in the application 8 and a clocking or monitoring of a start time to make a payment or digital property transfer is initiated, the next step of the processing of the crypto or digital property product is commenced. For example, application 8 may enable the processing of the cryptocurrency payment to the blockchain wallet of the corporate entity (e.g., the processing of the digital payment to the insurance company).

In some examples, the application 8 may enable an automated routine or script, and present or introduce a timing window to monitor or check that the user is or will make the payment. For example, the timing window that is introduced may assist the application 8 (or the crypto-processing system 100) in the digital payment processing by enabling or causing a secure matching of a digital transfer or payment to the policy (or that is due to the policy) of the customer 6.

In some examples, the user may perform a series of manual operations such as logging into the application 8 and indicating that she/he will be making a digital payment within a certain time. Application 8 will in response to the user input, begin to monitor the making or sending of the digital payment. For example, application 8 may monitor for a fixed or flexible amount of time for the payment or may monitor for a digital transfer or payment to the distributed account within a certain amount of time or within the time period.

In some examples, the customer 6 or user may manually copy and paste the insurance company's (or insurance entity's, or payees') payment address into their wallet. In an exemplary embodiment, the customer or payor would receive a confirmation immediately or nearly immediately in the customer or payor's blockchain crypto wallet that the payment has been sent to the manually inserted corporate crypto address. The customer or payor does not have to provide account information or other policy identification information to have the payment sent. For example, the user or payor may create or setup a payment rail by using an automated routine or script consisting of a crypto-distributed account address (e.g., a blockchain address) and by depositing the funds into a digital wallet that will store the cryptographic information and generate a special alphanumeric key each time before making a payment, a transfer or a transaction.

In some examples, once the payment has been sent, the user or customer can simply log into application 8, and application 8 will confirm that the payment has been sent. In some examples, application 8 may be configured to indicate that the payment has been received and the amount of the payment that has been received to the corporate blockchain wallet.

In some examples, application 8 may retain, or store the corporate wallet address and other metadata from the initial and/or prior payments sent, as a check when making a future payment. In some examples, because the user or customer 6, does not have to provide policy or policy identification with the crypto payment, application 8 enables the generated blockchain number for securing and making an anonymous payment from any or other independent crypto wallet so long as the payment is made within a certain time period, and it matches the customer's payment amount that is due or indicated in the application 8.

In some examples, the payment match may be an application-proximate match of the payment due or indicated in application 8 by the user, customer, or policyholder. In other words, it is contemplated that the payment sent via the smart contract of the payor may not always be exact or may be slightly different but based on making the payment within the time window and payment amount within a preconfigured or default margin or threshold, and the application 8 of the corporate entity (e.g., the insurance company) will be able to confirm with a high degree of reliability of the payment being received and matched to the correct policy in which the payment is due or desired to be paid.

In some examples, application 8 does not store or receive input of policy-specific information for generating the block number for payment processing. In other words, application 8 generates a payment link for processing the payment from an independent crypto wallet that is devoid of user-specific policy identification information to secure or match the payment to the policy. Therefore, the anonymity of the payor is maintained as the information on the source of payment is masked or isolated because application 8 is not given, nor does it have or receive any other information to associate with the payee in the generated link. Application 8 only can associate the payment to its timing. Application 8 generates a timing window that allows for monitoring by the corporate wallet of the payment timing (e.g., monitoring action within a certain timing window) and the payment amount which can then be associated with the policyholder. For example, the corporate wallet at any given time, may be receiving a series of payments, and by using the amount and timing information, it can associate a particular payment received to a particular policy.

In some examples, a smart contract responsible for taking in payments is applied to the blockchain and it is configured with the capability to emit the corporate wallet address and payment value.

In some examples, application 8 is configured to provide both an internal policy identifier and/or customer identifier 28 alongside the provided crypto virtual (e.g., Ethereum) wallet or distributed account address in a (distributed record payload scripted in JSON or other programming language) payload 24 to an event bridge 26 that looks to request the payment process. The event bridge 26 in this instance may make a settlement request that an on-chain payment has been processed on a payment rail. For example, the event bridge 26 may trigger various Lambda function λ (or other payment function) processes that have been scripted in the payload of the distributed record.

In some examples, at a settlement request 30, the function λ₁ that is called may match certain policy identifiers and a payment amount of the crypto value that has been sent to confirm the settlement of virtual amounts to a distributed account. For example, if a match is found, then the payload 32 will be sent to process the settlement via a processing settlement function 36 (e.g., settlement function λ₂). The processing settlement function 36 is configured to enable it to extract relevant data, keys, or other information from the payload and insert such information into a database (a Dynamo database, other databases with flexible schemas such as a “NoSQL” database, or a structured database such as “SQL” database). In some embodiments, a multi-cloud global database may be implemented using for example MONGODB®. The information in the database may then be used by another process function 40 (e.g., a user-created function such as a Lambda create process function λ₃) to determine the payment amount that has been added to the corporate wallet and to account for the payment against an amount that is due. Once the payment has been accounted for, the payment process is complete 42, and a receipt or other type of paid confirmation may be generated and sent to the user or customer 6 to provide different notices: an alert, a confirmation, etc., that the payment was received. In some instances, the notice may be generated even when the payment is still being processed, as the sender crypto wallet generation of a blockchain or a distributed account number by the sender's crypto wallet can be used by the crypto processing system as a notice of a perfected payment to the corporate wallet.

In some examples, methods, and systems are provided for the use of a general corporate crypto wallet address to receive independent crypto payments from different sources and to automate the payment process by creating a payment rail for streamlining the payment flow and enabling recurring on-chain payments that are due. The payment rails are created using links that identify distributed accounts or blockchain numbers for sending the payments to a corporate entity's wallet. The process for the payment rail may include generating a link to send the crypto property or digital currency transfer, performing a query operation to determine a block or account number of a record of a distributed account or blockchain wallet, providing information of a window to make or send the payment, and when sent, providing a confirmation notice that a digital or virtual property interest (e.g., the digital currency) has been received and/or accounted for by the corporate wallet for the policyholders account.

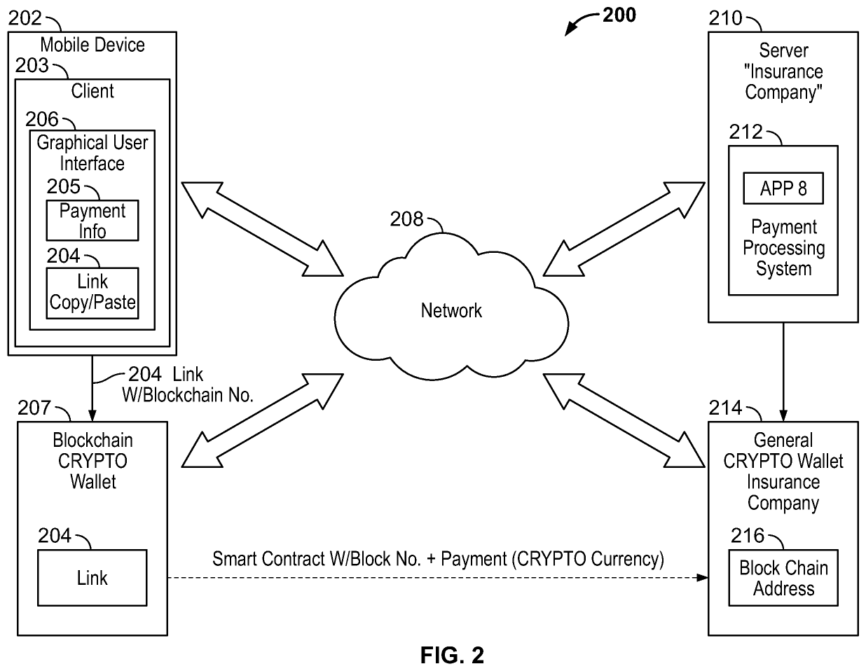

FIG. 2 shows an example network for processing the crypto payment according to some embodiments. In FIG. 2 there is shown network 200 illustrates a high-level diagram of some of the elements for the payment processing of FIG. 1 and the communication flow between the elements of application 8 that is operably coupled to a mobile device and the payment processing system for enabling a user to access information for making a crypto payment to the insurance company's blockchain wallet. It is contemplated that there are a variety of different configurations that may be applicable and used herein in a payment processing system, and also that there are other or different elements that may be used in the payment processing system.

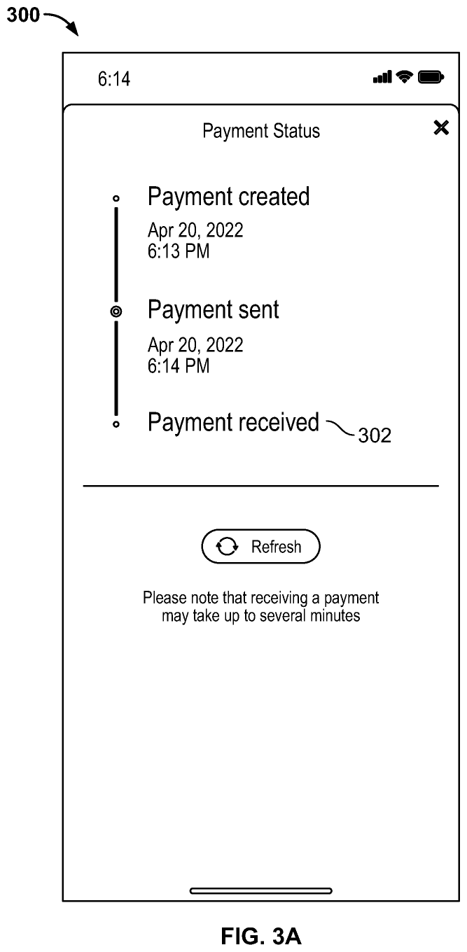

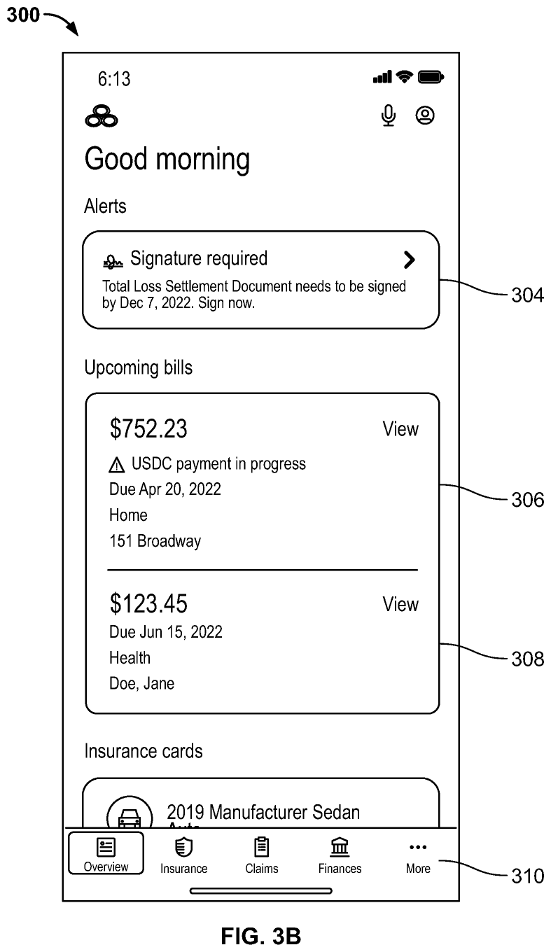

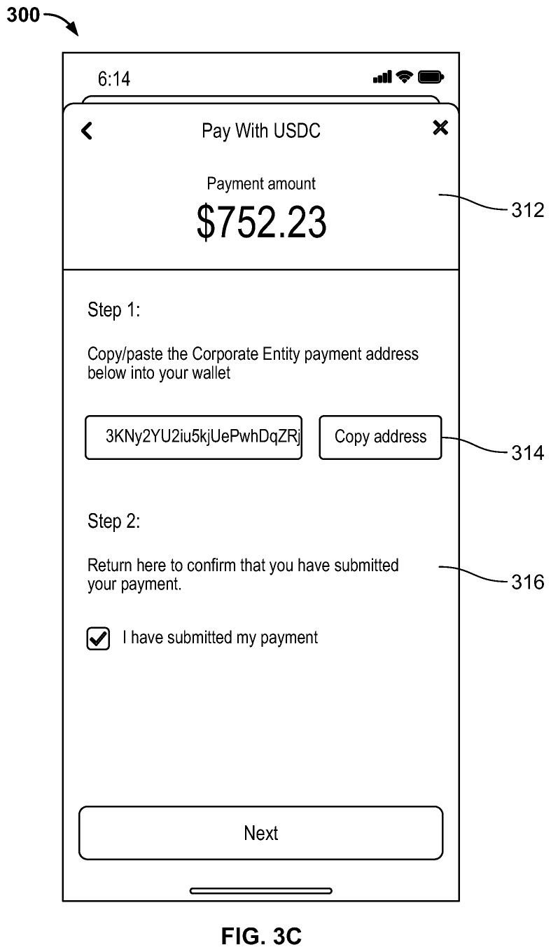

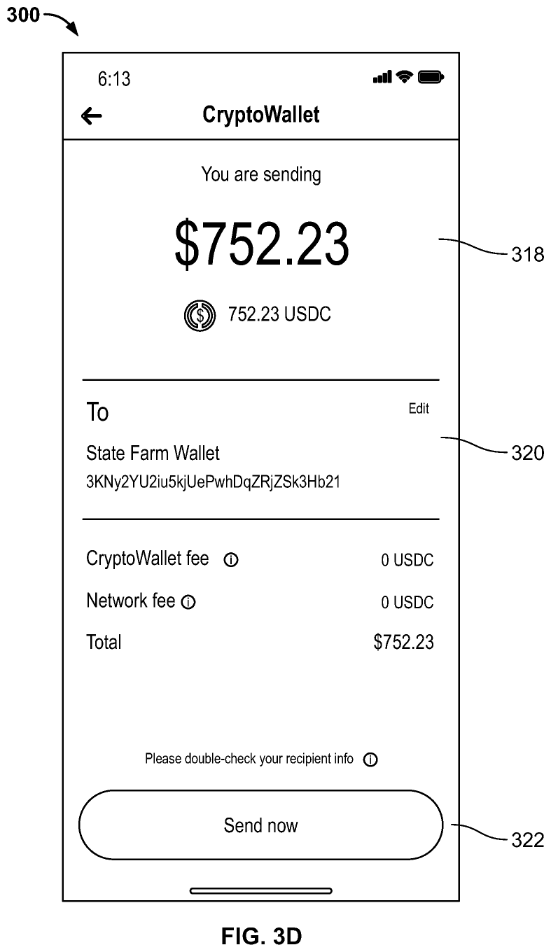

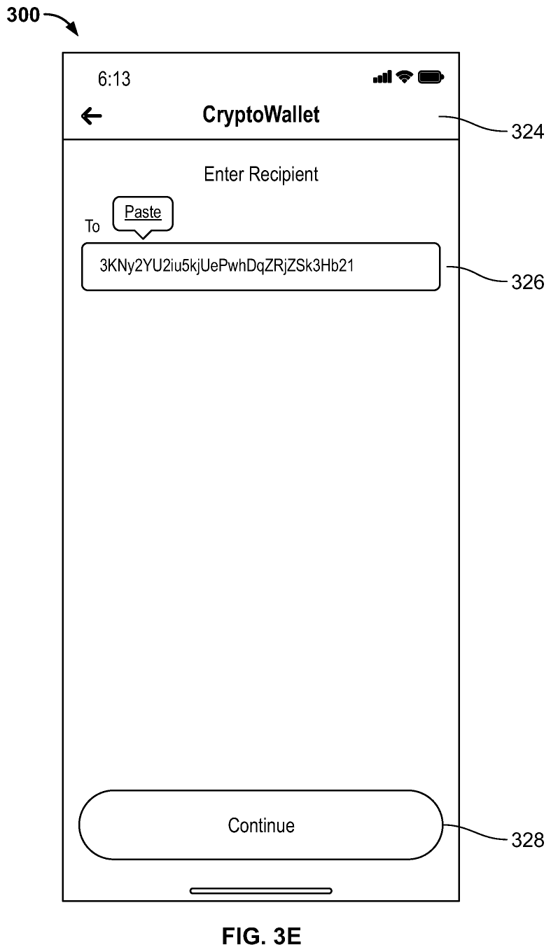

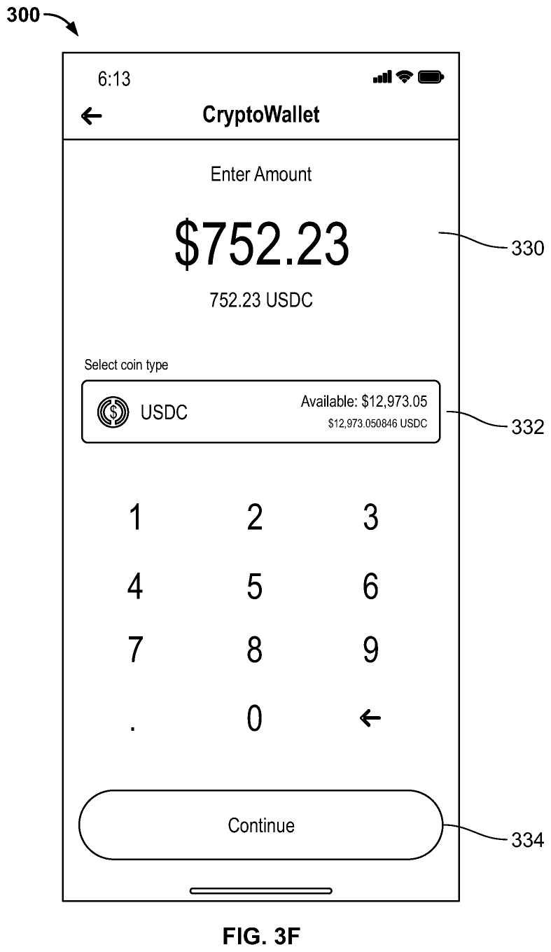

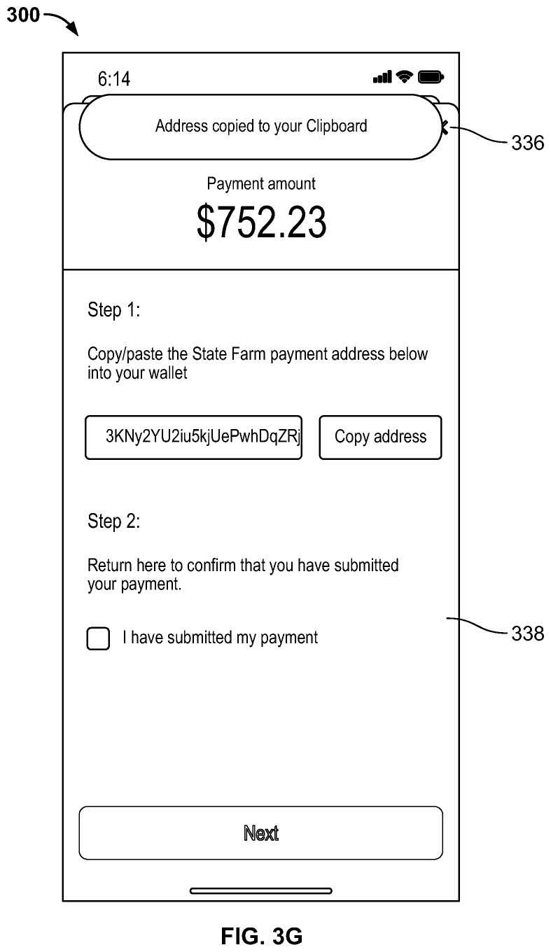

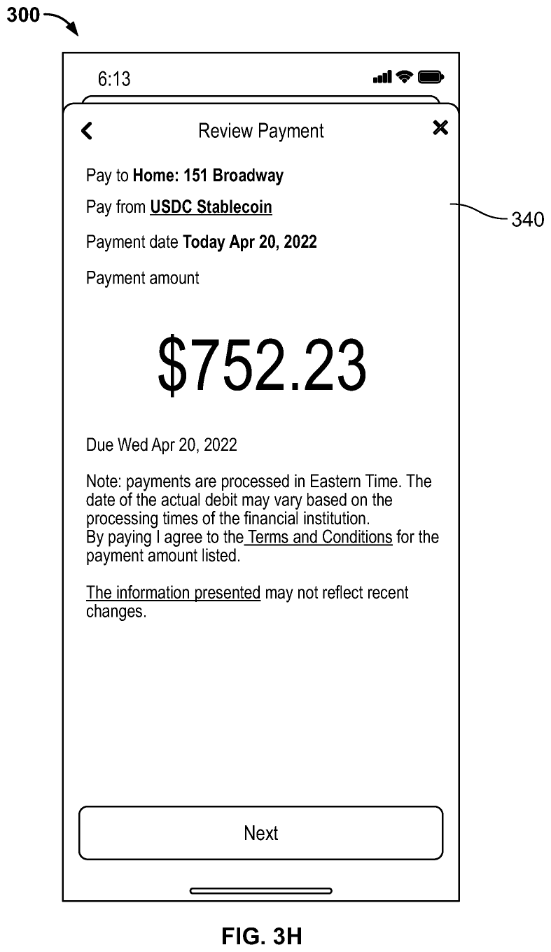

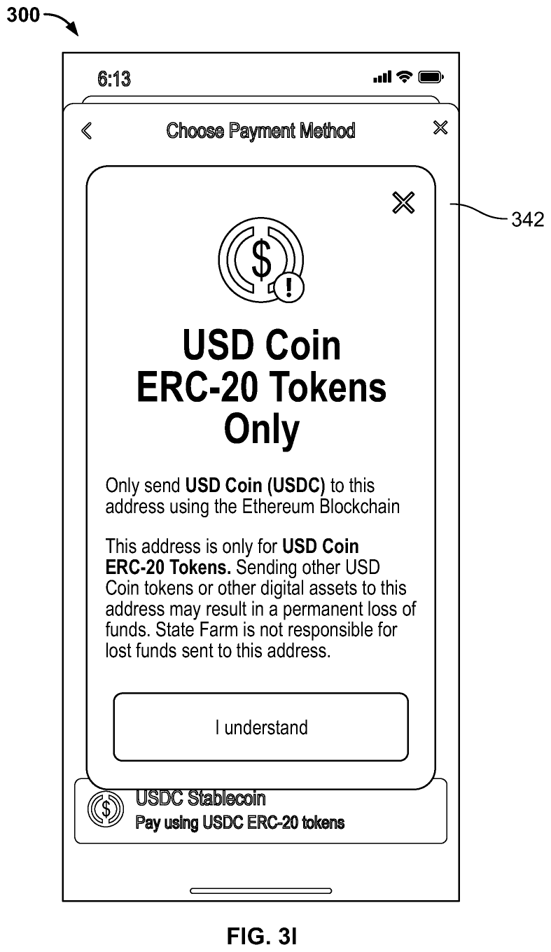

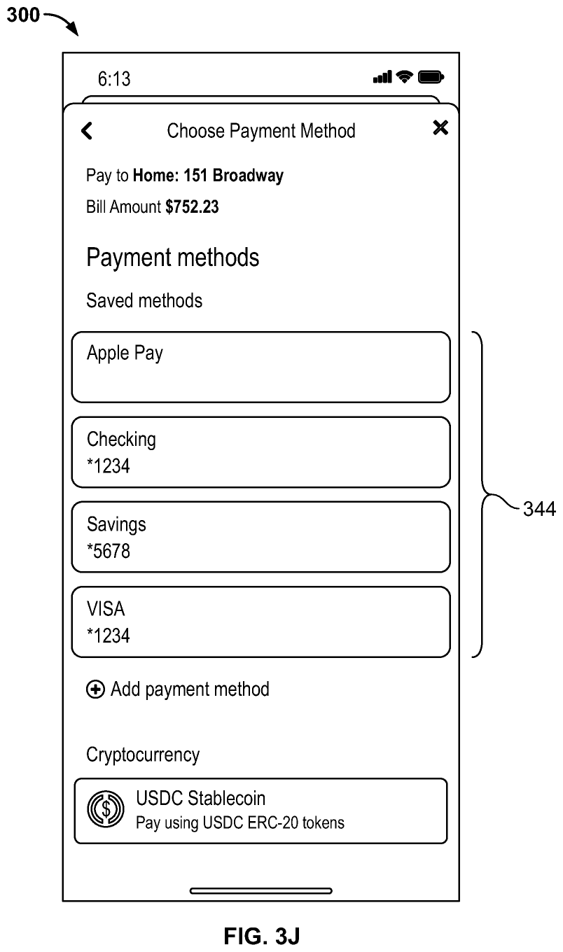

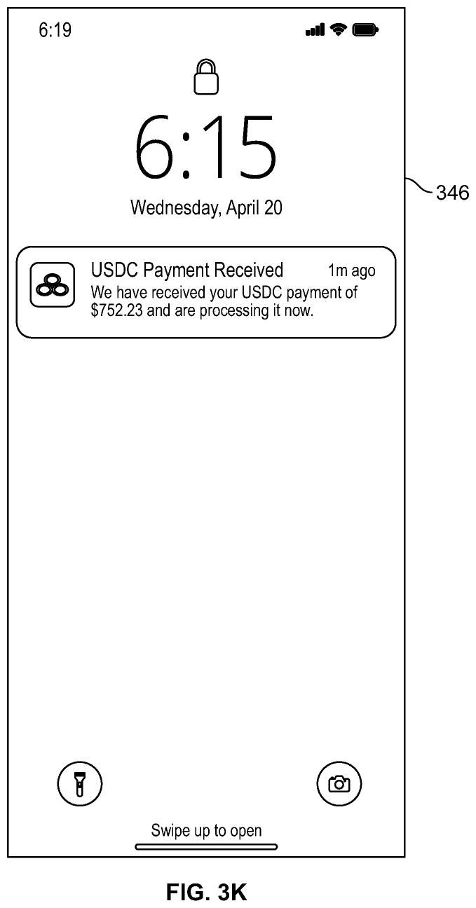

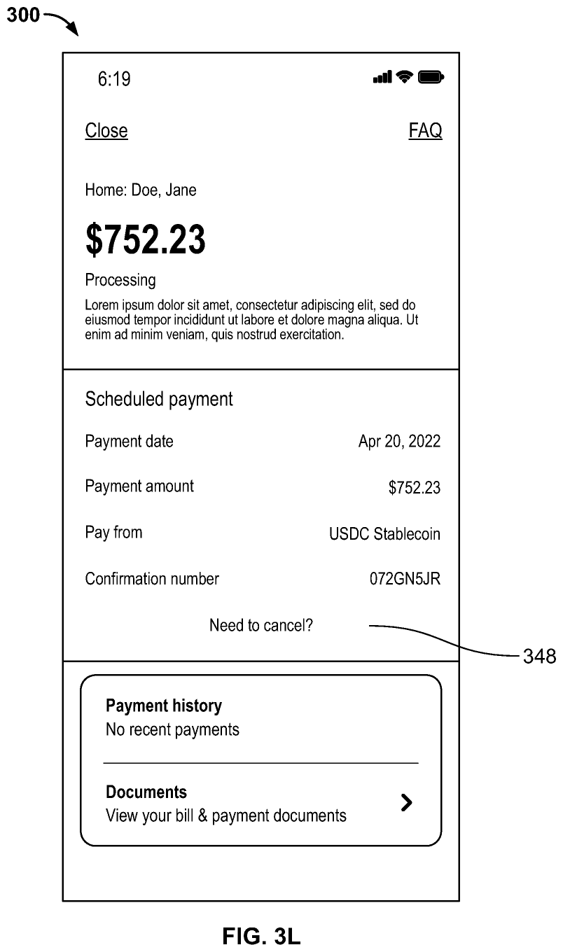

In FIG. 2, network 200 includes a mobile device 202 that is configured with a client 203 that is in operable communication with an application 8 for access to make payments and for payment information by a user. Application 8 may be operably coupled to send data to a graphical user interface (GUI) 206 that allows for displaying the series of screenshots in FIGS. 3A-L. The GUI 206 may include payment and policy information 205 for display and navigating the payment processing system to make the crypto payments to the insurance company's general crypto wallet. Also, the GUI 206 is capable of displaying a link that is generated by the application 8, and the display of the mobile device 202 is configured with select and copy features that allow a user to copy and paste the link 204 (generated with a blockchain number identifying the corporate general wallet address) in a blockchain wallet for use in sending a crypto payment to the insurance company's blockchain. While application 8 is shown to be integrated with the payment processing system 212 that is hosted by server 210, it is contemplated that the configuration of the payment processing system 212 and application 8 is not limited to the presented architecture and may be implemented in a variety of different configurations. For example, the payment processing system 212 may be configured to reside at a cloud server in operable communication with application 8, or integrated with application 8 and in operable communication with the mobile device 202 and the server 210 of the insurance company. In some embodiments, it is contemplated that a hybrid configuration may be implemented in which the application 8 and the payment processing system 212 reside or are hosted in part on the server 210 and in part on the mobile device 202 (e.g., libraries, routines, and data may reside in one or more locations of a system configuration, including backups of the data and applications).

In some examples, the link 204 is generated in the GUI 206 and may be copied and pasted into the wallet of a different payee or a wallet of the policyholder and/or for operable communication with the application 8 (e.g., pasted in the wallet 207). Also, the GUI 206 will provide a notification such as an overlay notification of the copy and paste of link 204. The GUI 206 is also configured with payment information and other information on actions and ongoing processing of the payment (payment information 205) which is further shown in FIGS. 3A-L. The network 208 provides a means of operably communicating data between the mobile device 202, the payor's crypto wallet (e.g., the crypto wallet 207), and the general corporate wallet 214 of the insurance entity that is configured with the address 216 which is identified and/or associated with the link 204. Also, network 208 enables communications with the crypto processing system (e.g., the payment processing system 212) that may reside at a server of the corporate entity (e.g., the insurance company), at a third party, or maybe a hybrid configuration of multiple servers (e.g., server 210) for payment processing and providing additional tools for verifying and validating the payment information of the sender or payor.

FIGS. 3A, 3B, 3C, 3D, 3E, 3F, 3G, 3H, 3I, 3J, 3K, and 3L show a series of example screenshots of the process flow for configuring a crypto wallet and sending a crypto payment to a general blockchain wallet (e.g., a corporate distributed account) of a corporate entity according to some embodiments.

In some examples, FIGS. A-L illustrates a set of screenshots that capture various displays of a graphical user interface that operably communicates with application 8 of a user communicating one or more requests to application 8 for processing a crypto payment to the general corporate wallet of an insurance company.

In some examples, FIG. 3A illustrates an exemplary screenshot 300 of a display of a graphical user interface providing a notification to a user of a payment received 302. The notification is presented when the payment is processed from a crypto wallet of the payor using the blockchain number operably communicated by application 8 and displayed in a graphical user interface that is configured for a smart contract of the payor when executing a payment from the payor's crypto wallet.

In some examples, FIG. 3B illustrates an exemplary screenshot 300 of a display of a graphical user interface providing a notification to a user of an initial greeting 304, and an action required of the customer or user (in this case a signature for a policy). Also displayed in the GUI is a notification of upcoming payments in progress 306 and upcoming payments due 308. Finally, shown in FIG. 3B, is a display of tab 310 for navigating to other features for display that are operably communicated by the application 8.

In some examples, FIG. 3C illustrates an exemplary screenshot 300 of a display of a Graphical User Interface (GUI) showing the notification of a payment amount due 312 and the first step of making a payment by using a generated link 314 to copy and paste into the smart contract of the payor (who may also be the customer or someone else), and a second step 316 for checking a box indicating the payment has been submitting using the link that was generated in the first step.

In some examples, FIG. 3D illustrates an exemplary screenshot 300 of a display of a graphical user interface of a crypto wallet display of the payor (who may also be the user or someone else) showing a display of a notification to the payor (individual making the crypto payment) of the payment being sent 318, the blockchain address 320 of the insurance company where payment is to be sent (e.g., the configuring of the smart contract to execute the payment) and the amount of the payment that is to be sent. Also, there is a button 322 for the payor to initiate and confirm that this is the payment to be sent after reviewing the display information from the designated crypto wallet.

In some examples, FIG. 3E illustrates an exemplary screenshot 300 of a display of a graphical user interface of a crypto wallet display 324 of the payor (who may also be the user or someone else) and the pasting of the copied link 326 that has been generated in the application 8 and includes the block number for where the payment is to be sent. There is also the button 328 to continue the operation and make the payment.

In some examples, FIG. 3F illustrates an exemplary screenshot 300 of a display of a Graphical User Interface (GUI) of a crypto wallet display of the amount of the payment 330, in this case, $752.23, the type of cryptocurrency 332 that is being used to make the payment, and button 334 to continue the operation of the payment processing from the designated crypto wallet.

In some examples, FIG. 3G illustrates an exemplary screenshot 300 of a display of a graphical user interface that reverts to the application display showing a prefilled graphical user interface that may be a notification (to a policy recipient or other payor) with the address copied to the clipboard 336, the payment due, the first step of making a payment using the copied generated link, and the second step 338 where the box is left unchecked (in a default state) until the payor makes the payment.

In some examples, FIG. 3H illustrates an exemplary screenshot 300 of a display of a graphical user interface of the crypto wallet display 340 that shows the confirmation of the payment terms of the address of the policyholder recipient of the payment, the type of cryptocurrency, the payment date, and the amount of the payment. Also displayed are the payment terms associated with the processing of the payment, and when the payment will be processed by the insurance company processing system. In other words, while the payment confirmation is immediate, the display of application 8 also includes information about a caveat that the processing time for the payment is dependent on processing times, and other terms and conditions.

In some examples, FIG. 3I illustrates an exemplary screenshot 300 of a display of a graphical user interface of a crypto wallet display 342 which is a confirmation of the payment of a certain number of crypto tokens as payment for the amount due for the policy of the insurance company.

In some examples, FIG. 3J illustrates an exemplary screenshot 300 of a display of a graphical user interface of an application display 344 that allows navigating and adding to other payment methods including APPLE® pay, checking account, credit card, etc., for the amount due for the policy of the insurance company.

In some examples, FIG. 3K illustrates an exemplary screenshot 300 of a display of a graphical user interface of crypto wallet display 346 of a receipt that the payment has been received and is being processed by the insurance company payment processing system.

In some examples, FIG. 3L illustrates an exemplary screenshot 300 of a display of a graphical user interface of application display 348 with a cancelation of payment feature that can be selected by the user for an upcoming payment for the policy.

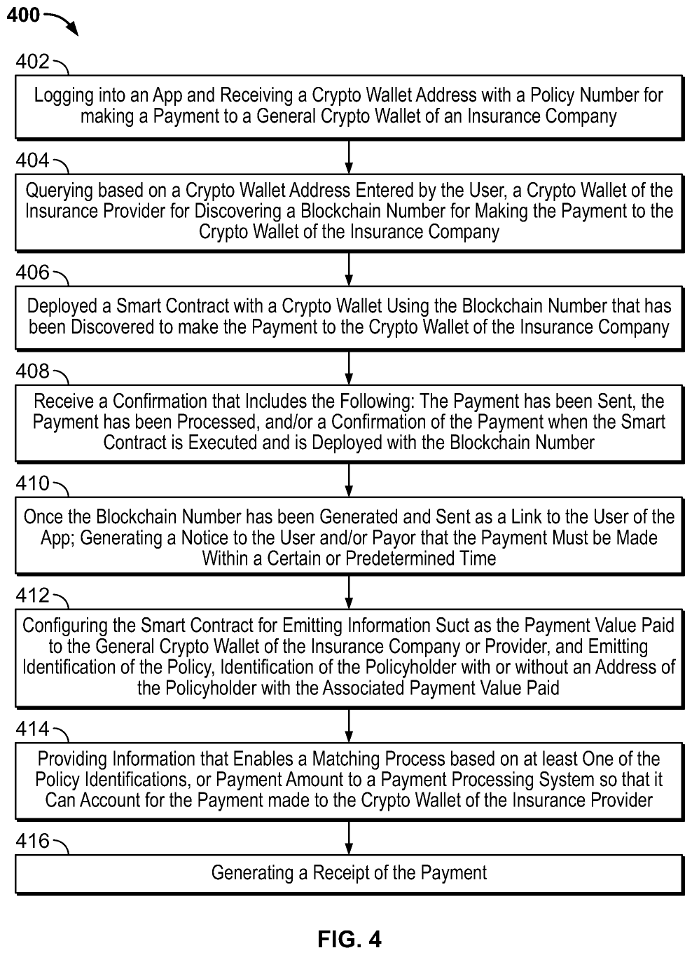

FIG. 4 shows a flowchart of an example method for processing a crypto payment according to some embodiments. In FIG. 4, flowchart 400 includes the steps of processing a crypto payment from a crypto wallet that is independent and configured based on a block number generated that identifies a general crypto wallet for making a payment. In some examples, a user using a mobile device that hosts a client and is configured with an application 8 that may be downloaded from GOOGLE® Play, APPLE® Play, or any other application depository.

In FIG. 4, the flowchart 400 (with reference to FIG. 1) at step 402, application 8 may receive a crypto wallet address of a corporate entity with a policy number for enabling payment to a crypto wallet of an insurance entity. In some examples, a crypto wallet address is a general corporate crypto wallet address that may also receive independent crypto payments from different sources and also enables the application 8 to automate the payment process by creating a payment rail for streamlining the payment flow to the corporate wallet and to enable one or more recurring on-chain payments that are due. In some examples, the payment rails are created using links that identify distributed accounts or blockchain numbers for sending the payments to a corporate entity's wallet.

At step 404, the application (or crypto processing system) may automatically (in response to a request from the user) query based on a crypto wallet address entered by the user, a crypto wallet of the insurance entity for discovering a blockchain number or distributed account number to enable the payment to the crypto wallet of the insurance entity. In some examples, application 8 is configured to use the data 10 to query the blockchain 14 (e.g., the Ethereum distributed account, blockchain) to get a blockchain number 16 (e.g., for example, to determine a distributed account number associated with a distributed account address) for use in processing a payment by the automated script or smart contract 18. In some examples, the blockchain number 16 (or block number, distributed record number, etc.) may be used by the automated routine of smart contract 18 that is applied by a payment sender's wallet to send a cryptocurrency 20. In some examples, the cryptocurrency 20 may include a variety of different digital products or digital property. For example, a virtual currency may be used that is a stable coin 22 (e.g., a crypto product that is valued or tied to another currency or financial instrument). In some examples, the stablecoin 22 is configured by a digital payload that can include JSON scripted or hashed payload 24 that is enabled in a payment rail of the application 8.

At step 406, a smart contract may be applied with a crypto wallet using the blockchain number that has been discovered by the application to make the payment to the crypto wallet of the insurance entity. In some examples, the customer 6 or user may manually copy and paste the insurance company's (or insurance entity's, or payees') payment address into the wallet. In an exemplary embodiment, the customer or payor would receive a confirmation immediately or nearly immediately in the customer or payor's blockchain crypto wallet that the payment has been sent to the manually inserted corporate crypto address. The customer or payor does not have to provide account information or other policy identification information to have the payment sent. For example, the user or payor may create or setup a payment rail by using an automated routine or script, a crypto-distributed account address (e.g., a blockchain address) by depositing the funds into a digital wallet that will store the cryptographic information and generate a special alphanumeric key each time before making one of a payment, a transfer or a transaction.

At step 408, the application is configured to receive a confirmation or notice that the payment has been sent, the payment has been processed, and/or a confirmation of the payment when the smart contract is executed and is applied with the blockchain number for making the payment to the general crypto wallet of the insurance entity. In some examples, once the payment has been sent, the user or customer can simply log into a GUI that operably communicates with application 8, and application 8 will provide a notice of confirmation that the payment has been sent. In some examples, application 8 may be configured to indicate that the payment has been received and the amount of the payment that has been received to the corporate blockchain wallet.

At step 410, once the blockchain number has been generated and sent as a link to the user of the application; the application or crypto payment processing system also is configured to generate a notice to the user and/or payor that the payment must be made within a certain or predetermined time. In other words, application 8 may require that the payment be made within a time window, and if it is made within the time window (e.g., submitted to the payment processing system) then the user and/or payor will receive the confirmation of it being made. In some examples, the user may be required to log back into the application and confirm that the payment has been submitted and upon making this confirmation of the submission, will receive a notice of the payment.

At step 412, the smart contract may be configured to emit information such as the payment value that has been paid to the general crypto wallet of the insurance company or entity, and also it may emit identification of the policy, identification of the policyholder with or without an address of the policyholder with the associated payment value that was made. At step 414, the application may also provide information that enables a matching process based on at least one of the policy identifications, or payment amount to a payment processing system so that it can account for the payment made to the crypto wallet of the insurance entity.

At step 416, the application or the payment processing system may generate a receipt of the payment. The receipt may be generated on a mobile device that hosts the application, and the smart contract that has been applied may either be applied by the application user or another party who is the payor who sends the payment from the payor's own crypto wallet. An acknowledgment of the payment different than the confirmation may be independently sent to the payor. In some examples, application 8 may retain, or store the corporate wallet address and other metadata from the initial and/or prior payments sent, as a check when making a future payment. In some examples, because the user or customer 6, does not have to provide policy or policy identification with the crypto payment, application 8 enables the generated blockchain number for securing and making an anonymous payment from any or other independent crypto wallet so long as the payment is made within a certain time period, and it matches the customer's payment amount that is due or indicated in the application 8.

In some examples, flowchart 400 provides for making payments to a corporate entity crypto wallet address that has been set up to receive independent crypto payments of different virtual currencies or virtual properties (e.g., digital currencies) to be credited to a policyholder's account. The payments can be from independent sources and application 8 allows for an automated payment process by creating a payment rail for streamlining the payment flow and enabling recurring on-chain payments that are due. The payment rails are created using links that identify distributed accounts or blockchain numbers for sending the payments to a corporate entity's wallet.

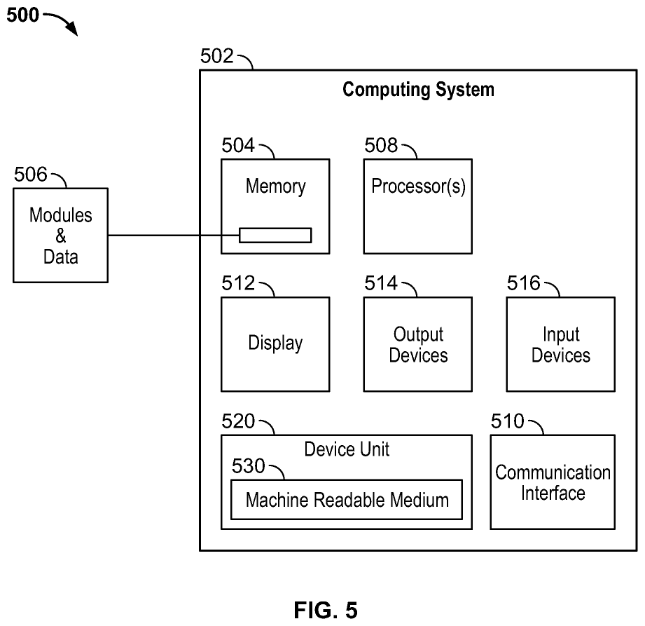

FIG. 5 shows an example system architecture 500 for a computing system that can host the application and process the crypto payment according to some embodiments.

The computing system 502 can include memory 504. In various examples, the memory 504 can include system memory, which may be volatile (such as RAM), non-volatile (such as ROM, flash memory, etc.), or some combination of the two. The Memory 504 can further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media. Examples of non-transitory computer-readable media include but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 502 associated with cryptocurrency processing systems. Any such non-transitory computer-readable media may be part of the computing system 502.

The memory 504 can store modules and data. The modules and data can include data and/or software or firmware elements, such as data and/or computer-readable instructions that are executable by one or more processors 508. For example, memory 504 can store computer-executable instructions and data associated with the various elements of the cryptocurrency processing systems described, such as data and/or computer-executable instructions associated with the application 8 that is communicated to the mobile device 202 from the crypto processing system (e.g., the payment processing system 212), and/or other elements described herein. The Memory 504 can also store other modules and data 506, such as any other modules and/or data that can be utilized by the computing system 502 to perform or enable performing any action taken by the computing system 502. Such other modules and data 506 can include a platform, operating system, and application locations, and data utilized by the platform, operating system, and application locations.

The computing system 502 can also have processor(s) 508, communication interfaces 510, a display 512, output devices 514, input devices 516, and/or a drive unit 520 including a machine-readable medium 530.

In various examples, the processor(s) 508 can be a central processing unit (CPU), a graphics processing unit (GPU), both a CPU and a GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing computer applications stored in memory 504, which can be associated with common types of volatile (RAM) and/or nonvolatile (ROM) memory.

The communication interfaces 510 can include transceivers, modems, interfaces, antennas, telephone connections, and/or other components that can transmit and/or receive data over networks, telephone lines, or other connections. In some examples, the communication interface 510 can be used by the payment processing system 212 of the application 8.

The display 512 can be a liquid crystal display, or any other type of display commonly used in computing devices. For example, a display 512 may be a touch-sensitive display screen and can then also function as an input device or keypad, such as for providing a soft-key keyboard, navigation buttons, or any other type of input.

The output devices 514 can include any sort of output devices known in the art, such as the display 512, speakers, a vibrating mechanism, and/or a tactile feedback mechanism. Output devices 514 can also include ports for one or more peripheral devices, such as headphones, peripheral speakers, and/or a peripheral display.

The input devices 516 can include any sort of input devices known in the art. For example, input devices 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine-readable medium of the drive unit 520 can store one or more sets of instructions, such as software or firmware, which embody any one or more of the methodologies or functions described herein. The instructions can also reside, completely or at least partially, within the memory 504, processor(s) 508, and/or communication interface(s) 510 during execution thereof by the computing system 502. The memory 504 and the processor(s) 508 also can constitute machine-readable media.

Clause 1. A method for sending on-chain digital property, comprising: configuring, at an application, an address of a crypto-distributed account with a policy number for creating a digital property rail to transfer the on-chain digital property using the address from the application to a crypto-distributed account used by a corporate entity; querying, by the application using the crypto-distributed account address to discover the address used by the crypto-distributed account of the corporate entity; in response to discovering the crypto-distributed account address of the corporate entity, recording, by the application, a distributed record number associated with the crypto-distributed account address of the corporate entity that receives the transfer by the digital property rail of the on-chain digital property being sent on the crypto-distributed account of the corporate entity; and executing an automated routine associated with the crypto-distributed account using the distributed record number to make the transfer of the on-chain digital property to the crypto-distributed account of the corporate entity.

Clause 2. The method of clause 1, further comprising: in response to receiving the distributed record number by the application, sending the on-chain digital property using the digital property rail to the crypto-distributed account of the corporate entity within a predetermined time.

Clause 3. The method of clause 1, further comprising: configuring the automated routine to emit at least a digital property value of the on-chain digital property sent to the crypto-distributed account of the corporate entity.

Clause 4. The method of clause 1, further comprising: in response to executing the automated routine, receiving a confirmation by the application of transferring of the on-chain digital property to the crypto-distributed account of the corporate entity.

Clause 5. The method of clause 1 further comprising: providing, by the application, at least one of a policy identifier or a policyholder identifier when transferring the on-chain digital property to the crypto-distributed account of the corporate entity.

Clause 6. The method of clause 5, further comprising: providing, by the application, information to match the on-chain digital property to at least one of a policy identifier or an amount of the on-chain digital property for an accounting of transferring of the on-chain digital property to the crypto-distributed account of the corporate entity.

Clause 7. The method of clause 6, further comprising: in response to receiving the accounting of the on-chain digital property to the crypto-distributed account of the corporate entity, generating by the application a receipt of a transfer of digital property.

Clause 8. The method of clause 7, wherein the application is hosted by a client device.

Clause 9. The method of clause 8, wherein the automated routine for on-chain digital property is executed on a different digital property rail.

Clause 10. The method of clause 9, wherein the automated routine is configured to emit at least an address of a policyholder associated with the digital property to the crypto-distributed account of the corporate entity.

Clause 11. A system, comprising: at least one memory; and at least one processor coupled to the at least one memory, wherein the at least one processor is configured to: configure an address of a crypto-distributed account with a policy number to create a digital property rail to send the on-chain digital property using the address to a crypto-distributed account used by a corporate entity; query the crypto-distributed account address to discover the address used by the crypto-distributed account of the corporate entity; in response to discovering the crypto-distributed account address of the corporate entity, record a distributed record number associated with the crypto-distributed account address of the corporate entity that receives the on-chain digital property being sent on the crypto-distributed account of the corporate entity; and execute an automated routine associated with the crypto-distributed account using the distributed record number to make a transfer of the on-chain digital property to the crypto-distributed account of the corporate entity.

Clause 12. The system of clause 11, wherein the at least one processor is further configured to: send the on-chain digital property using the digital property rail to the crypto-distributed account of the corporate entity within a predetermined time.

Clause 13. The system of clause 12, wherein the at least one processor is further configured to: cause the automated routine to emit at least a digital property value of the on-chain digital property sent to the crypto-distributed account of the corporate entity.

Clause 14. The system of clause 13, wherein the at least one processor is further configured to: cause the automated routine to emit at least an address of a policyholder associated with the on-chain digital property to the crypto-distributed account of the corporate entity.

Clause 15. The system of clause 14, wherein the at least one processor is further configured to: provide at least one of a policy identifier or a policyholder identifier when sending the on-chain digital property to the crypto-distributed account of the corporate entity.

Clause 16. The system of clause 15, wherein the at least one processor is further configured to: provide information to match the on-chain digital property to at least one of a policy identifier or an amount of the on-chain digital property to account for sending of the on-chain digital property to the crypto-distributed account of the corporate entity.

Clause 17. The system of clause 15, wherein the at least one processor is further configured to: in response to receiving an account of the on-chain digital property to the crypto-distributed account of the corporate entity, generate a receipt of digital property.

Clause 18. One or more non-transitory computer-readable media storing instructions executable by a processor, wherein the instructions, when executed by the processor, cause the processor to perform operations comprising: configuring an address of a crypto-distributed account with a policy number for creating a digital property rail to transfer the on-chain digital property using the address to a crypto-distributed account used by a corporate entity; querying the crypto-distributed account address to discover the address used by the crypto-distributed account of the corporate entity; in response to discovering the crypto-distributed account address of the corporate entity, recording a distributed record number associated with the crypto-distributed account address of the corporate entity that receives the on-chain digital property being sent to the crypto-distributed account of the corporate entity; and executing an automated routine associated with the crypto-distributed account using the distributed record number to make a transfer of the on-chain digital property to the crypto-distributed account of the corporate entity.

Clause 19. The one or more non-transitory computer-readable media of clause 18, wherein the instructions, when executed by the processor, cause the processor to further perform operations comprising: in response to receiving the distributed account number, sending the on-chain digital property using the digital property rail to the crypto-distributed account of the corporate entity within a predetermined time.

Clause 20. The one or more non-transitory computer-readable media of clause 19, wherein the instructions, when executed by the processor, cause the processor to further perform operations comprising: in response to executing the automated routine via the digital property rail of the on-chain digital property, receiving a confirmation of the on-chain digital property being sent to the crypto-distributed account of the corporate entity.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method for sending on-chain digital property, comprising:
configuring, at an application, an address of a crypto-distributed account with a policy number for creating a digital property rail to transfer the on-chain digital property using the address from the application to a crypto-distributed account used by a corporate entity;
querying, by the application using the crypto-distributed account address to discover the address used by the crypto-distributed account of the corporate entity;
in response to discovering the crypto-distributed account address of the corporate entity, recording, by the application, a distributed record number associated with the crypto-distributed account address of the corporate entity that receives the transfer by the digital property rail of the on-chain digital property being sent on the crypto-distributed account of the corporate entity; and
executing an automated routine associated with the crypto-distributed account using the distributed record number to make the transfer of the on-chain digital property to the crypto-distributed account of the corporate entity.

2. The method of claim 1, further comprising:
in response to receiving the distributed record number by the application, sending the on-chain digital property using the digital property rail to the crypto-distributed account of the corporate entity within a predetermined time.

3. The method of claim 1, further comprising:
configuring the automated routine to emit at least a digital property value of the on-chain digital property sent to the crypto-distributed account of the corporate entity.

4. The method of claim 1, further comprising:
in response to executing the automated routine, receiving a confirmation by the application of transferring the on-chain digital property to the crypto-distributed account of the corporate entity.

5. The method of claim 1 further comprising:
providing, by the application, at least one of a policy identifier or a policyholder identifier when transferring the on-chain digital property to the crypto-distributed account of the corporate entity.

6. The method of claim 5, further comprising:
providing, by the application, information to match the on-chain digital property to at least one of a policy identifier or an amount of the on-chain digital property for an accounting of transferring of the on-chain digital property to the crypto-distributed account of the corporate entity.

7. The method of claim 6, further comprising:
in response to receiving the accounting of the on-chain digital property to the crypto-distributed account of the corporate entity, generating by the application a receipt of a transfer of digital property.

8. The method of claim 7, wherein the application is hosted by a client device.

9. The method of claim 8, wherein the automated routine for on-chain digital property is executed on a different digital property rail.

10. The method of claim 9, wherein the automated routine is configured to emit at least an address of a policyholder associated with the digital property to the crypto-distributed account of the corporate entity.

11. A system, comprising:
at least one memory; and
at least one processor coupled to the at least one memory, wherein the at least one processor is configured to:
configure an address of a crypto-distributed account with a policy number to create a digital property rail to send the on-chain digital property using the address to a crypto-distributed account used by a corporate entity;
query the crypto-distributed account address to discover the address used by the crypto-distributed account of the corporate entity;
in response to discovering the crypto-distributed account address of the corporate entity, record a distributed record number associated with the crypto-distributed account address of the corporate entity that receives the on-chain digital property being sent on the crypto-distributed account of the corporate entity; and
execute an automated routine associated with the crypto-distributed account using the distributed record number to make a transfer of the on-chain digital property to the crypto-distributed account of the corporate entity.

12. The system of claim 11, wherein the at least one processor is further configured to:
send the on-chain digital property using the digital property rail to the crypto-distributed account of the corporate entity within a predetermined time.

13. The system of claim 12, wherein the at least one processor is further configured to:
cause the automated routine to emit at least a digital property value of the on-chain digital property sent to the crypto-distributed account of the corporate entity.

14. The system of claim 13, wherein the at least one processor is further configured to:
cause the automated routine to emit at least an address of a policyholder associated with the on-chain digital property to the crypto-distributed account of the corporate entity.

15. The system of claim 14, wherein the at least one processor is further configured to:
provide at least one of a policy identifier or a policyholder identifier when sending the on-chain digital property to the crypto-distributed account of the corporate entity.

16. The system of claim 15, wherein the at least one processor is further configured to:
provide information to match the on-chain digital property to at least one of the policy identifier or an amount of the on-chain digital property to account for sending the on-chain digital property to the crypto-distributed account of the corporate entity.

17. The system of claim 15, wherein the at least one processor is further configured to:
in response to receiving an account of the on-chain digital property to the crypto-distributed account of the corporate entity, generate a receipt of digital property.

18. One or more non-transitory computer-readable media storing instructions executable by a processor, wherein the instructions, when executed by the processor, cause the processor to perform operations comprising:
configuring an address of a crypto-distributed account with a policy number for creating a digital property rail to transfer the on-chain digital property using the address to a crypto-distributed account used by a corporate entity;
querying the crypto-distributed account address to discover the address used by the crypto-distributed account of the corporate entity;
in response to discovering the crypto-distributed account address of the corporate entity, recording a distributed record number associated with the crypto-distributed account address of the corporate entity that receives the on-chain digital property being sent to the crypto-distributed account of the corporate entity; and
executing an automated routine associated with the crypto-distributed account using the distributed record number to make a transfer of the on-chain digital property to the crypto-distributed account of the corporate entity.

19. The one or more non-transitory computer-readable media of claim 18, wherein the instructions, when executed by the processor, cause the processor to further perform operations comprising:
in response to receiving the distributed account number, sending the on-chain digital property using the digital property rail to the crypto-distributed account of the corporate entity within a predetermined time.

20. The one or more non-transitory computer-readable media of claim 19, wherein the instructions, when executed by the processor, cause the processor to further perform operations comprising:
in response to executing the automated routine via the digital property rail of the on-chain digital property, receiving a confirmation of the on-chain digital property being sent to the crypto-distributed account of the corporate entity.
